(19) United States
(12) Patent Application Publication
(10) Pub. No.: US 2026/0014945 A1
(43) Pub. Date: Jan. 15, 2026

(54) ENERGY STORAGE APPARATUS

(71) Applicant: GS Yuasa International Ltd., Kyoto-shi, Kyoto (JP)

(72) Inventor: Akihito UMEDA, Kyoto-shi, Kyoto (JP)

(21) Appl. No.: 18/880,438

(22) PCT Filed: Jun. 27, 2023
(86) PCT No.: PCT/JP2023/023723

§ 371 Date: Dec. 31, 2024

(30) Foreign Application Priority Data
Jul. 6, 2022 (JP) 2022-109013

(51) Int. Cl. B60R 16/033; H02J 7/00

(52) U.S. Cl. CPC B60R 16/033; H02J 7/00302; H02J 7/00306; H02J 7/00309; H02J 7/0031; H02J 2310/40

(57) ABSTRACT

An energy storage apparatus includes a cell, a relay which cuts off a current of the cell, a bypass circuit connected in parallel with the relay, and a management device. The bypass circuit includes two back-to-back connected FETs. When an abnormality of the cell is detected by the management device, the management device opens the relay, closes one FET of the two FETs, and opens the other FET, and permits a discharge or a charge of the cell through a path passing through a parasitic diode of the FET. When the discharge or the charge is being performed through the path passing through the parasitic diode, if a current I and an energization time T of the FET(s) reach a predetermined condition or the temperature of the FET(s) reaches a predetermined condition, the management device 150 closes the relay 53 and the other FET(s) that is open.

### CROSS REFERENCE TO RELATED APPLICATIONS

This application is a National Stage Application, filed under 35 U.S.C. § 371, of International Application No. PCT/JP2023/023723, filed Jun. 27, 2023, which international application claims priority to and the benefit of Japanese Application No. 2022-109013, filed Jul. 6, 2022; the contents of both of which are hereby incorporated by reference in their entirety.

### BACKGROUND

### Technical Field

The present application generally relates to a technique for protecting an FET.

### Description of Related Art

One example of a battery protective device includes a relay. If an abnormality such as over-discharge or overcharge is detected, it is possible to open a relay and cut off a current to protect a battery. JP 2021-34297 A indicated below discloses that a bypass circuit is provided in parallel with a relay. The bypass circuit is configured from two back-to-back connected FETs.

### BRIEF SUMMARY

It is considered that a bypass circuit may be used to control a charge and a discharge while the relay is open.

Specifically, in a first FET and a second FET that are connected back-to-back, the directions of parasitic diodes thereof are reversed. That is, the direction of the parasitic diode of the first FET is set to a charging direction and the direction of the parasitic diode of the second FET is set to a discharging direction.

In this case, in a state in which the relay is open, when the first FET is closed and the second FET is opened, only a discharge is permitted through a path passing through the parasitic diode of the second FET.

Therefore, for example, when an overcharge is detected, by opening the relay, closing the first FET, and opening the second FET, only a discharge is permitted through the path passing through the parasitic diode of the second FET while restricting a charge.

However, energization causes the parasitic diode to generate heat. Therefore, if a current exceeding a permissible value flows through the parasitic diode for a predetermined time or more, the FET may break down.

Further, in the case of an over-discharge, the relay is opened, the first FET is opened, and the second FET is closed. By doing so, only a charge can be performed through a path passing through the parasitic diode of the first FET while restricting a discharge. Also in this case, a similar problem arises.

An object of the present invention is to suppress a breakdown of an FET caused by generation of heat by a parasitic diode.

An energy storage apparatus includes a cell, a relay which cuts off a current of the cell, a bypass circuit connected in parallel with the relay, and a management device. The bypass circuit includes two FETs that are connected back-to-back.

When an abnormality of the cell is detected by the management device, the management device opens the relay, closes one FET of the two FETs, and opens the other FET, and permits a discharge or a charge of the cell through a path passing through a parasitic diode of the FET.

When the discharge or the charge is being performed through the path passing through the parasitic diode, if a current I and an energization time T of the FET reach a predetermined condition or the temperature of the FET reaches a predetermined condition, the management device closes the relay and the other FET that is open.

When the discharge or the charge is being performed through the path passing through the parasitic diode, if the current I and the energization time T of the FET reach a predetermined condition or the temperature of the FET reaches a predetermined condition, the management device maintains the relay to be open and closes the other FET that is open.

The present technique can suppress a breakdown of the FET caused by generation of heat by the parasitic diode.

### BRIEF DESCRIPTION OF THE FIGURES

FIG. 1 is a side view of an automobile.

FIG. 2 is an exploded perspective view of a battery.

FIG. 3 is a plan view of a cell.

FIG. 4 is a cross-sectional view taken along line A-A of FIG. 3.

FIG. 5 is a block diagram illustrating an electrical configuration of a battery.

FIG. 6 shows an I-T characteristic.

FIG. 7 is a diagram illustrating a current path of a battery.

FIG. 8 is a diagram illustrating a current path of a battery.

FIG. 9 shows I-T characteristics.

FIG. 10 is a flowchart of FET protection processing.

FIG. 11 is a flowchart of FET protection processing.

FIG. 12 is a diagram illustrating a current path of a battery.

FIG. 13 is a diagram illustrating a current path of a battery.

FIG. 14 is a flowchart of FET protection processing.

FIG. 15 is a block diagram illustrating an electrical configuration of a battery.

FIG. 16 is a block diagram illustrating an electrical configuration of a battery.

### DETAILED DESCRIPTION OF VARIOUS EMBODIMENTS

An outline of an energy storage apparatus will be described.

(1) An energy storage apparatus according to an embodiment of the present invention includes a cell, a relay which cuts off a current of the cell, a bypass circuit connected in parallel with the relay, and a management device. The bypass circuit includes two FETs that are connected back-to-back.

When an abnormality of the cell is detected by the management device, the management device opens the relay, closes one FET of the two FETs, and opens the other FET, and permits a discharge or a charge of the cell through a path passing through a parasitic diode of the FET.

When the discharge or the charge is being performed through the path passing through the parasitic diode, if a current I and an energization time T of the FET reach a predetermined condition or the temperature of the FET reaches a predetermined condition, the management device closes the relay and the other FET that is open.

The energy storage apparatus described in (1) above brings about the following advantages. It is assumed that the FET on one side is opened while the relay is open, and the cell is being discharged or charged through a path passing through a parasitic diode of the FET that is open. At this time, in a case where there is a breakdown risk of the FET by the generation of heat by the parasitic diode, if the relay and the FET that is open are simultaneously closed, the FET having no contact is closed earlier than the relay having a contact. By the closure of the FET, an energizable current of the bypass circuit increases as compared to that before the closure. Thus, it is possible to suppress heat generation of the FET and suppress a breakdown of the FET. After the FET has been closed, the contact of the relay is closed later. Here, after the contact of the relay has been closed, the energizable current further increases, and most of the current flows through the relay. Thus, it is possible to further suppress a breakdown of the FET.

(2) An energy storage apparatus according to an embodiment of the present invention includes a cell, a relay which cuts off a current of the cell, a bypass circuit connected in parallel with the relay, and a management device. The bypass circuit includes two FETs that are connected back-to-back.

When an abnormality of the cell is detected by the management device, the management device opens the relay, closes one FET of the two FETs, and opens the other FET, and permits a discharge or a charge of the cell through a path passing through a parasitic diode of the FET.

When the discharge or the charge is being performed through the path passing through the parasitic diode, if a current I and an energization time T of the FET reach a predetermined condition or the temperature of the FET reaches a predetermined condition, the management device maintains the relay to be open and closes the other FET that is open.

The energy storage apparatus described in (2) above brings about the following advantages. It is assumed that the FET on one side is opened while the relay is open, and the cell is being discharged or charged through a path passing through a parasitic diode of the FET that is open. At this time, in a case where there is a breakdown risk of the FET by the generation of heat by the parasitic diode, the FET that is open is closed. By doing so, an energizable current of the bypass circuit is increased as compared to that before the FET is closed. As the energizable current is increased, heat generation of the FET is suppressed, and a breakdown of the FET can be suppressed. In addition, since the relay is maintained to be open, operation sounds, such as a chattering sound caused by the opening and closing of a contact, are not generated. Therefore, for example, when the present technique is applied to an energy storage apparatus mounted on an automobile, it is possible to expect such an effect as the countermeasures against unpleasant noise while riding in a car.

(3) In the energy storage apparatus according to (1) or (2) above, the abnormality of the cell may be an overcharge or an over-discharge. With this configuration, it is possible to take measures against a breakdown of the FET while protecting the cell from the overcharge or over-discharge.

(4) In the energy storage apparatus according to any one of (1) to (3) above, the energy storage apparatus may be an apparatus for starting an engine. The energy storage apparatus for starting an engine discharges a large current. Therefore, when cranking is performed in a state in which the relay is controlled to be open, a large current flows through the parasitic diode of the bypass circuit, and the possibility that the FET will break down is high. In particular, at the time of overcharge, since a cell voltage is high and a cranking current tends to be large, there is a high possibility that the FET will break down. By applying the present technique to an energy storage apparatus for starting an engine which discharges a large current, it is possible to supply a cranking current while suppressing a breakdown of an FET even when the energy storage apparatus is in a state of being overcharged.

In the case of an over-discharge, a voltage of the cell is low and a current tends to be low. By turning on the two FETs, it becomes possible to reduce a resistance value of the bypass circuit and suppress a voltage drop of the energy storage apparatus. Therefore, a cranking failure caused by the voltage reduction and the current shortage can be suppressed.

### Embodiment 1

### 1. Description of Battery 50

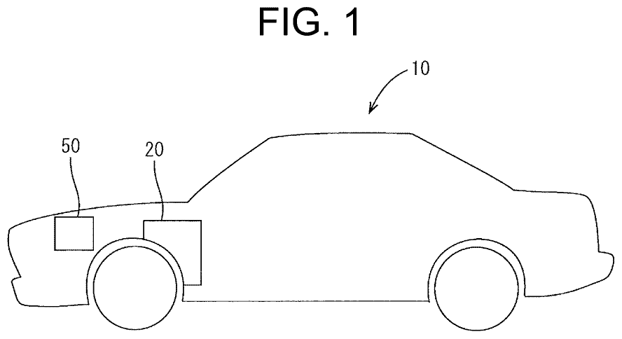

As illustrated in FIG. 1, on an automobile 10, an engine 20 and a battery 50 used for starting the engine 20, for example, are mounted. The battery 50 is an example of an “energy storage apparatus”. On the automobile 10, an energy storage apparatus for driving a vehicle and a fuel cell may be mounted.

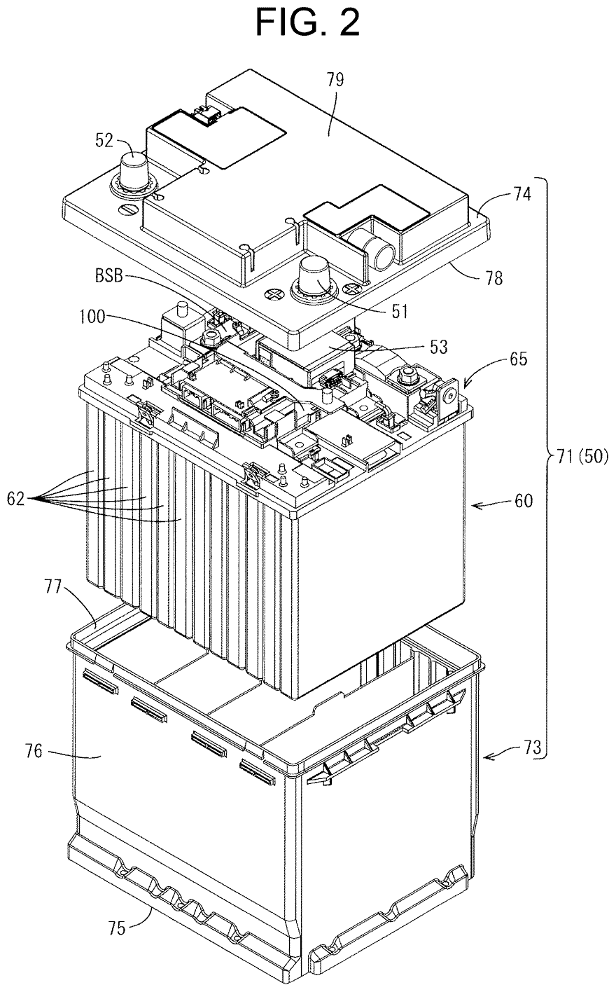

As illustrated in FIG. 2, the battery 50 is provided with an assembled battery 60, a circuit board unit 65, and a housing body 71. The housing body 71 is provided with a main body 73 and a lid body 74 made of a synthetic resin material. The main body 73 has a bottom-closed cylindrical shape, and is provided with a bottom surface portion 75 and four side surface portions 76. By the presence of four side surface portions 76, an opening portion 77 is formed at an upper end of the main body 73.

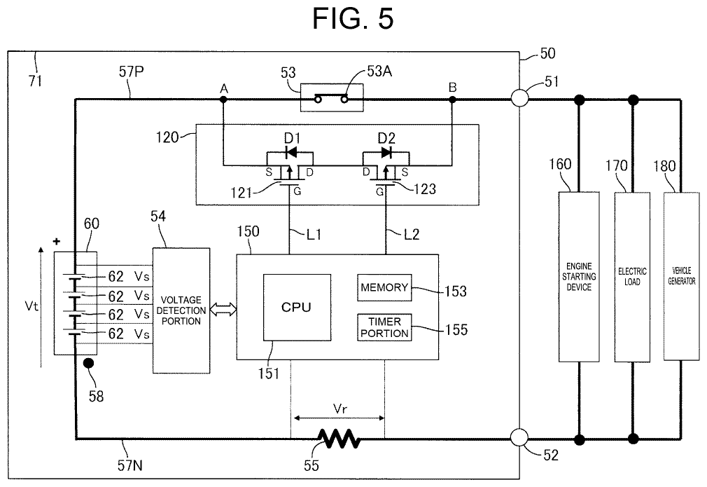

The housing body 71 houses therein the assembled battery 60 and the circuit board unit 65. The circuit board unit 65 is a board unit with various components (a relay 53, a bypass circuit 120 and a management device 150, etc., indicated in FIG. 5) mounted on a circuit board 100, and is arranged, for example, above and adjacent to the assembled battery 60, as illustrated in FIG. 2. Alternatively, the circuit board unit 65 may be arranged laterally adjacent to the assembled battery 60.

The lid body 74 closes the opening portion 77 of the main body 73. An outer peripheral wall 78 is provided around the lid body 74. The lid body 74 has a protruding portion 79 which is substantially T-shaped in plan view. A positive external terminal 51 is fixed to one corner portion of the front part of the lid body 74, and a negative external terminal 52 is fixed to the other corner portion. The circuit board unit 65 may be housed inside the lid body 74 (for example, inside the protruding portion 79), instead of the main body 73 of the housing body 71.

The assembled battery 60 is configured from a plurality of cells 62. As illustrated in FIG. 4, the cell 62 is obtained by housing an electrode body 83 in a rectangular parallelepiped (a prismatic) case 82 together with a non-aqueous electrolyte. The cell 62 is, for example, a lithium ion secondary battery cell. The case 82 includes a case main body 84 and a lid 85 which closes an opening portion above the case main body 84.

Although not illustrated in detail, the electrode body 83 is obtained by arranging a separator, which is made of a porous resin film, between a negative plate on which an active material is applied to a base material that is made of copper foil and a positive plate on which an active material is applied to a base material that is made of aluminum foil. These elements are all strip-shaped, and are wound in a flat shape such that they can be accommodated in the case main body 84 in such a state that the negative plate and the positive plate are positionally shifted from each other on the opposite sides in a width direction with respect to the separator. The electrode body 83 may be a laminated type instead of the wound type.

A positive terminal 87 is connected to the positive plate via a positive collector 86, and a negative terminal 89 is connected to the negative plate via a negative collector 88, respectively. Each of the positive collector 86 and the negative collector 88 includes a flat plate-shaped base portion 90 and a leg portion 91 extending from the base portion 90. A through hole is formed in the base portion 90. The leg portion 91 is connected to the positive plate or the negative plate.

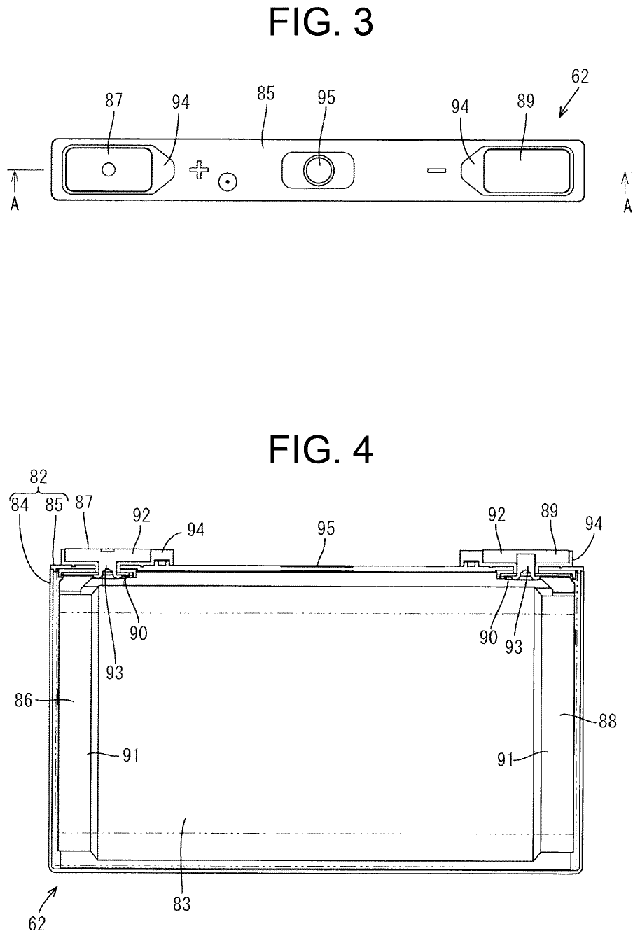

Each of the positive terminal 87 and the negative terminal 89 is configured from a terminal main body portion 92 and a shaft portion 93 protruding downward from a central part of a lower surface of the terminal main body portion 92. The terminal main body portion 92 and the shaft portion 93 of the positive terminal 87 are integrally formed of aluminum (a single material). In the negative terminal 89, the terminal main body portion 92 is made of aluminum and the shaft portion 93 is made of copper, and they are assembled together. The terminal main body portions 92 of the positive terminal 87 and the negative terminal 89 are disposed at both end portions of the lid 85 via gaskets 94 made of an insulating material. As indicated in FIG. 3, they are exposed to the outside from the gaskets 94.

The lid 85 includes a pressure relief valve 95. The pressure relief valve 95 is located between the positive terminal 87 and the negative terminal 89. The pressure relief valve 95 is a safety valve. When an internal pressure of the case 82 exceeds a limit, the pressure relief valve 95 opens and lowers the internal pressure of the case 82.

FIG. 5 is a block diagram illustrating an electrical configuration of the battery 50. The battery 50 is provided with the assembled battery 60, the relay 53, a voltage detection portion 54, a current sensor 55, a temperature sensor 58, the bypass circuit 120, and the management device 150.

An engine starting device 160, an electric load 170 of an auxiliary machine or the like, and a vehicle generator 180 are electrically connected to the battery 50.

During driving of the engine 20, when an amount of power generated by the vehicle generator 180 is greater than an amount of power consumed by the electric load 170, the battery 50 is charged by the vehicle generator 180. When the amount of power generated by the vehicle generator 180 is smaller than the amount of power consumed by the electric load 170, the battery 50 discharges electricity to compensate for the shortage.

When the engine 20 is being stopped, the vehicle generator 180 stops the power generation. When the power generation is being stopped, the battery 50 is brought into a state of not being charged, and is in a state in which only a discharge is performed for the electric load 170.

The number of cells 62 of the assembled battery 60 is, for example, twelve (see FIG. 2), and three cells are connected in parallel as a set and four such sets are connected in series. In FIG. 5, three cells 62 connected in parallel are represented by one battery symbol. The cell is not limited to a prismatic cell, and may be a cylindrical cell or a pouch cell having a laminated film case.

The assembled battery 60, the relay 53, and the current sensor 55 are connected in series via a power line 57P and a power line 57N. For the power lines 57P and 57N, a bus bar BSB (see FIG. 2), which is a plate-shaped conductor made of a metallic material such as copper, can be used.

As illustrated in FIG. 5, the power line 57P connects the positive external terminal 51 to the positive pole of the assembled battery 60. The power line 57N connects the negative external terminal 52 to the negative pole of the assembled battery 60.

The external terminals 51 and 52 are terminals for connecting the battery 50 to the automobile 10 (the engine starting device 160, the electric load 170, and the vehicle generator 180). The battery 50 can be electrically connected to the engine starting device 160, the electric load 170, and the vehicle generator 180 via the external terminals 51 and 52.

The current sensor 55 is provided on the negative power line 57N. The current sensor 55 may be a metal plate-shaped resistor (a shunt resistor). The current sensor 55 measures a current I of the assembled battery 60 on the basis of a voltage Vr between both ends of the resistor. The current sensor 55 can distinguish between a discharge and a charge from the polarity (positive or negative) of the voltage Vr between both ends.

The voltage detection portion 54 measures a cell voltage Vs of each of the cells 62 and a total voltage Vt of the assembled battery 60. The temperature sensor 58 is attached to the assembled battery 60, and detects the temperature of the assembled battery 60 or the surroundings thereof.

The relay 53 is provided on the positive power line 57P. The relay 53 should preferably be a self-holding type switch, such as a latching relay. The present embodiment uses a latching relay.

The relay 53 is of a normally closed type, and is controlled to be closed in a normal condition. Should there be any abnormality in the battery 50, the current I of the assembled battery 60 can be cut off by switching the relay 53 from closed to open.

The bypass circuit 120 is provided with a first FET 121 and a second FET 123. In the present embodiment, a P-channel is used for the first FET 121 and the second FET 123. The FET is a field-effect transistor.

As illustrated in FIG. 5, the first FET 121 connects the source S to one end portion (point A) of the relay 53, and the second FET 123 connects the source S to the other end portion (point B) of the relay 53.

The first FET 121 and the second FET 123 connect the drains to each other, and are connected back-to-back. The back-to-back connection is to connect between the drains or the sources of FETs.

The first FET 121 has a parasitic diode D1, and the second FET 123 has a parasitic diode D2. In the parasitic diode D1, a charging direction is set to a forward direction, and in the parasitic diode D2, a discharging direction is set to a forward direction. Thus, the directions are opposite to each other.

The gate G of the first FET 121 and the gate G of the second FET 123 are connected to the management device 150 via signal lines L1 and L2, respectively. The management device 150 can individually control the FET 121 and the FET 123 by sending control signals to the FET 121 and the FET 123, respectively, via the signal lines L1 and L2.

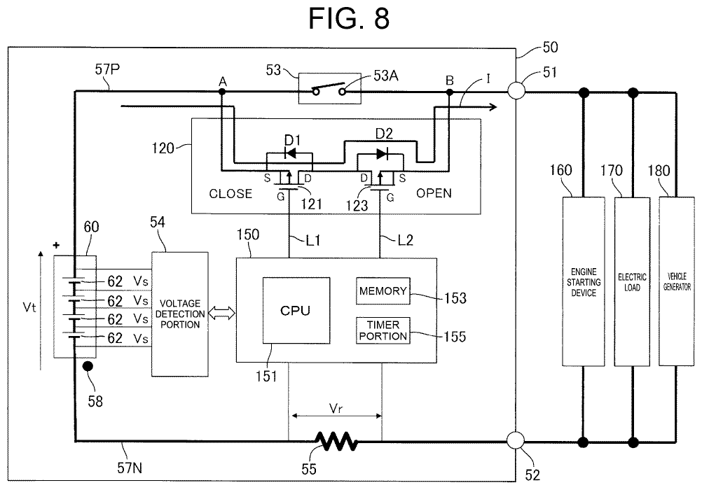

The bypass circuit 120 is connected in parallel to the relay 53. While the relay is open, by closing the first FET 121 and opening the second FET 123, the assembled battery 60 can perform a discharge to the automobile 10 through a path passing through the bypass circuit 120 (i.e., a path passing through the source-drain of the first FET 121 and the parasitic diode D2 of the second FET 123: see FIG. 8). In this case, the parasitic diode D2 prevents a charge from being conducted.

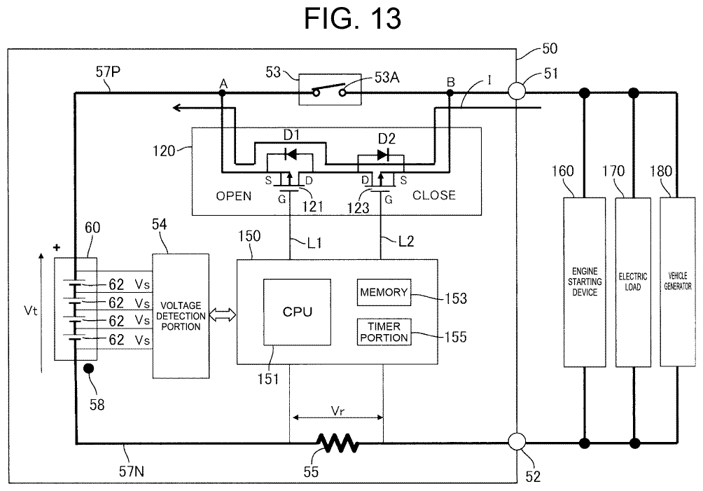

While the relay is open, by opening the first FET 121 and closing the second FET 123, the assembled battery 60 can be charged through a path passing through the bypass circuit 120 (i.e., a path passing through the source-drain of the second FET 123 and the parasitic diode D1 of the first FET 121: see FIG. 13). In this case, the parasitic diode D1 prevents a discharge from being conducted.

The management device 150 is mounted on the circuit board 100 (see FIG. 2), and is provided with a CPU 151, a memory 153, and a timer portion 155, as illustrated in FIG. 5.

The management device 150 monitors the state of the battery 50 on the basis of the outputs of the voltage detection portion 54, the current sensor 55, and the temperature sensor 58. In other words, the temperature, the current I, and the total voltage Vt of the assembled battery 60 are monitored.

The memory 153 stores a monitoring program of the battery 50, an execution program of the FET protection processing, and data necessary for execution of these programs. The program may be stored in a recording medium, such as a CD-ROM, and be used, transferred, lent, or the like. The program may be distributed by using a telecommunication line.

The timer portion 155 is used to measure an energization time of the first FET 121 and the second FET 123.

### 2. I-T Characteristic of FET

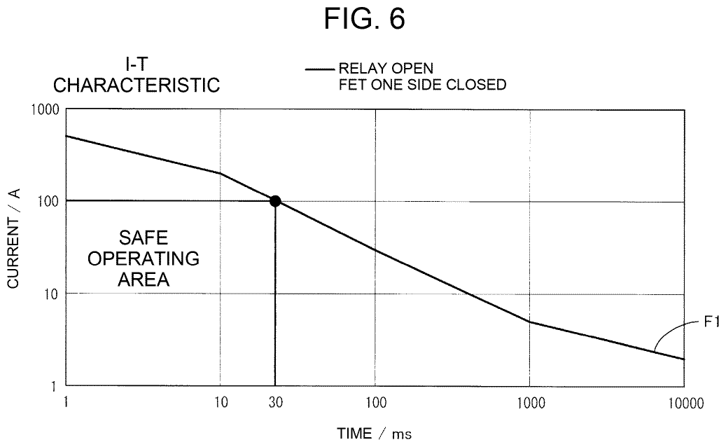

F1 indicated in FIG. 6 shows the I-T characteristic of the FET in which the horizontal axis represents the energization time T and the vertical axis represents the current I. Specifically, F1 is the I-T characteristic of the FET in a case where the second FET 123 is opened, and a current is passed through the parasitic diode D2.

An area on the lower side of F1 as the boundary line is a safe operating area assuring that the second FET 123 operates safely. In an area on the upper side of F1 as the boundary line, the second FET 123 may break down due to generation of heat by the parasitic diode D2.

For example, in a case where a current value is 100 A, if the time is less than 30 milliseconds, the second FET 123 is within the safe operating area and operates safely. However, if the time is 30 milliseconds or more, the second FET 123 is out of the safe operating area and may break down. The I-T characteristic of the first FET 121 is the same as the I-T characteristic of the second FET 123.

### 3. Overcharge Protection and Generation of Heat by Parasitic Diode

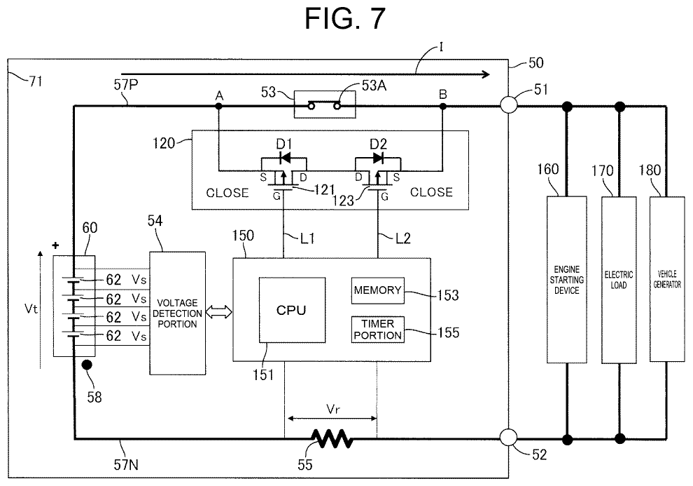

As illustrated in FIG. 7, in a normal condition, the relay 53, the first FET 121, and the second FET 123 are all controlled to be closed. A contact resistance of the relay 53 is smaller than on-resistances of the first FET 121 and the second FET 123, and most of the current I passes through the relay 53. The total voltage Vt of the assembled battery 60 increases by a charge and decreases by a discharge.

When the total voltage Vt of the assembled battery 60 exceeds an upper limit value during a charge, the management device 150 judges that the assembled battery 60 is overcharged, and switches the relay 53 from “closed” to “open”. In addition, the first FET 121 is maintained to be closed, and second FET 123 is switched from “closed” to “open”.

By causing the first FET 121 to be closed and the second FET 123 to be open, as illustrated in FIG. 8, even after an overcharge has been detected, a discharge can be performed through a path passing through the source-drain of the first FET 121 and the parasitic diode D2 of the second FET 123.

When a large discharge current flows through the parasitic diode D2 and the second FET 123 is out of the safe operating area of the I-T characteristic, the second FET 123 may break down due to generation of heat by the parasitic diode D2.

In order to suppress a breakdown of the second FET 123, one course of action which can be taken is to close the relay 53 and reduce the current of the second FET 123.

However, since the relay 53 has a mechanical contact 53A, an operation time of the relay 53 is long. Thus, it takes time to switch the contact 53A after a command has been transmitted from the management device 150. Therefore, in a case where a relatively large current is discharged to the parasitic diode D2, the second FET 123 may break down before the contact 53A is closed.

In the present embodiment, after an overcurrent is detected, when there is a possibility of a breakdown of the second FET 123 during a discharge through a path passing through the parasitic diode D2, the management device 150 transmits a command for switching the relay 53 from “open” to “closed”, and simultaneously transmits a command for switching the second FET 123 from “open” to “closed”.

Since the second FET 123 is a semiconductor switch, an operation time of the second FET 123 is shorter than that of the relay 53 which is a mechanical switch. The operation time is the time required from when a command is transmitted to a switch until the state of that switch is actually changed.

When the commands are transmitted to the relay 53 and the second FET 123 simultaneously, the second FET 123 is closed in several tens of nanoseconds, and then the contact of the relay is closed later.

An allowable current between the drain and the source of the second FET 123 is greater than an allowable current of the parasitic diode D2. Therefore, it is possible to increase an energizable current of the bypass circuit 120 for ten-odd milliseconds until the contact 53A of the relay 53 is closed after the second FET 123 has been closed. Consequently, it is possible to suppress a breakdown of the second FET 123 due to the heat generation.

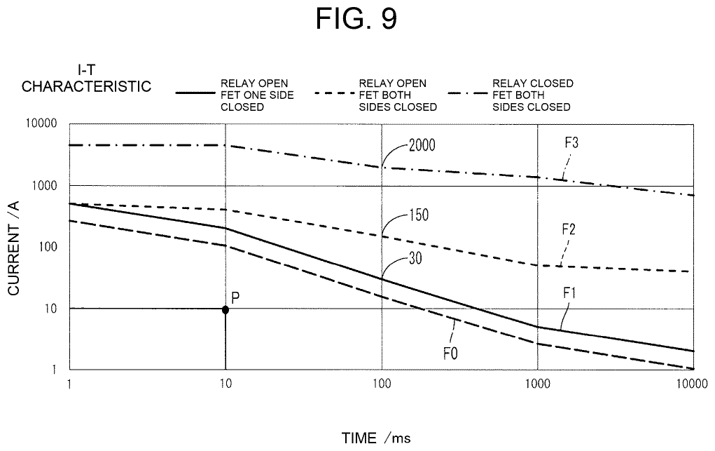

F0 to F3 indicated in FIG. 9 each show the I-T characteristic in which the horizontal axis represents the energization time T and the vertical axis represents the current I.

Specifically, F1 represents the I-T characteristic of a case where the relay 53 is opened, the first FET 121 is closed, and the second FET 123 is opened, and a current is passed through the parasitic diode D2. F2 represents the I-T characteristic of a case where the relay 53 is opened and the first FET 121 and the second FET 123 are closed, and a current is passed between the source and the drain of each of the first FET 121 and the second FET 123. F3 represents the I-T characteristic of a case where the relay 53 is closed and the first FET 121 and the second FET 123 are closed, and a current is passed between the contacts of the relay 53.

The safe operating areas are more extensive in the order of F3, F2, and F1, and the allowable currents are larger in the order of the relay 53, the source-drain of the second FET 123, and the parasitic diode D2 of the second FET 123. Specifically, when Tis 100 milliseconds, the allowable current of the relay 53 is approximately 2000 A, the allowable current of the drain-source of the second FET 123 is 150 A, and the allowable current of the parasitic diode of the second FET 123 is approximately 30 A.

F0 represents an I-T determination line for switching the relay 53 and the second FET 123 from “open” to “closed” for FET protection.

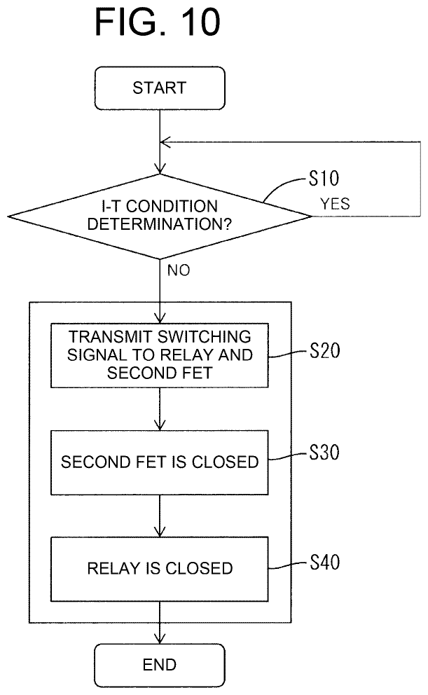

FIG. 10 is a flowchart of FET protection processing. The FET protection processing is executed in a case of, as illustrated in FIG. 8, permitting only a discharge (in which a charge is restricted) through a path passing through the parasitic diode D2 of the second FET 123, after the relay 53 is shut off in accordance with overcharge detection.

At a start point of the FET protection processing, the relay 53 is open, the first FET 121 is closed, and the second FET 123 is open (see FIG. 8).

The FET protection processing is constituted of four steps, which are S10 to S40. The management device 150 judges, in S10, an I-T condition of the second FET 123. Specifically, an operating point P, which is defined by the current I and the energization time T of the second FET 123, is compared against the I-T determination line F0 indicated in FIG. 9, and a judgment is made whether the operating point P of the second FET 123 is below the I-T determination line F0. The I-T condition is an example of a predetermined condition of the present invention.

When the operating point P of the second FET 123 is on the lower side of the I-T determination line F0, the management device 150 maintains the first FET 121 to be closed, and the second FET 123 to be open.

If the operating point P of the second FET 123 is moved to the upper side exceeding the I-T determination line F0, the processing proceeds to S20, and the management device 150 simultaneously transmits switching signals for making a switch from “open” to “closed” to the relay 53 and the second FET 123.

Since the operation time of the FET is shorter than the operation time of the relay 53, the second FET 123 is closed first (S30). An allowable current between the drain and the source of the second FET 123 is greater than an allowable current of the parasitic diode D2. For example, when T is 100 milliseconds, the allowable current of the drain-source is approximately 150 A, and the allowable current of the parasitic diode D2 of the second FET 123 is approximately 30 A.

Therefore, after the second FET 123 has been closed, an energizable current of the bypass circuit 120 can be increased. Therefore, it is possible to suppress a breakdown of the second FET 123 due to the heat generation.

After the second FET 123 has been closed, the relay 53 is closed later (S40). When the relay 53 is closed, after the closure, most of the discharge current flows through the relay 53. Thus, the current of the bypass circuit 120 is decreased and heat generation of the second FET 123 is further suppressed.

### Embodiment 2

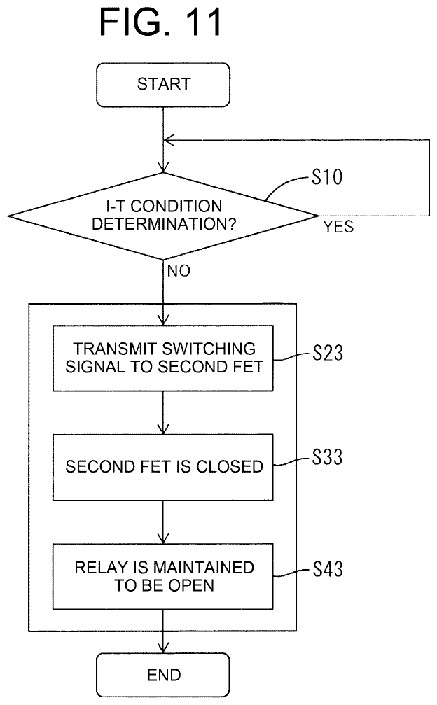

FIG. 11 is a flowchart of FET protection processing according to Embodiment 2. As in Embodiment 1, the FET protection processing is executed in a case of, as illustrated in FIG. 8, controlling a first FET 121 to be closed and a second FET 123 to be open after a relay 53 is shut off in accordance with overcharge detection, and permitting only a discharge (in which a charge is restricted) through a path passing through a parasitic diode D2 of the second FET 123.

As in Embodiment 1, after opening the relay 53 by detection of an overcharge, a management device 150 determines whether an operating point P of a bypass circuit 120 is on the lower side of an I-T determination line F0 (S10).

If the operating point P of the second FET 123 has exceeded the I-T determination line F0 (S10: NO), the management device 150 does not transmit a switching signal to the relay 53, but transmits the switching signal for making a switch from “open” to “closed” to only the second FET 123 (S23).

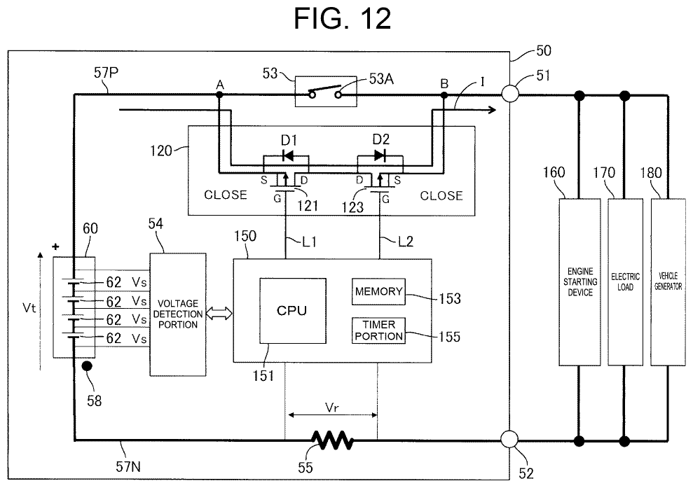

As illustrated in FIG. 12, the second FET 123 is switched from “open” to “closed” in response to the switching signal (S33), and the relay 53 is maintained to be open (S43).

An allowable current of the drain-source of the second FET 123 is greater than an allowable current of the parasitic diode D2. For example, when Tis 100 milliseconds, the allowable current of the drain-source is approximately 150 A, and the allowable current of the parasitic diode D2 of the second FET 123 is approximately 30 A.

By closing the second FET 123 and increasing the allowable current, it is possible to suppress a breakdown of the second FET 123 as compared to the case of continuing to pass a current through the parasitic diode D2.

When a charge is detected by the management device 150 after closing the second FET 123 (i.e., after S33), the management device 150 can switch the second FET 123 from “closed” to “open”, thereby interrupting the charge.

In Embodiment 2, the FET protection processing is performed with only the second FET 123. Therefore, as compared to Embodiment 1 in which the FET protection processing is performed by using the second FET 123 and the relay 53, it is possible to reduce the number of operations of the relay 53. By reducing the number of operations of the relay 53, it is possible to expect such an effect as the countermeasures against unpleasant noise while riding in a car.

### Embodiment 3

In Embodiment 1, in a case where an overcharge is detected, the relay 53 is opened, the first FET 121 is closed, and the second FET 123 is opened to enable only a discharge through a path passing through the bypass circuit 120 (the parasitic diode D2), as illustrated in FIG. 8.

In a case where an over-discharge is detected (i.e., a case where the total voltage Vt of the assembled battery 60 falls below a lower limit voltage), the relay 53 may be opened, the first FET 121 may be opened, and the second FET 123 may be closed to enable only a charge through a path passing through the bypass circuit 120 (the parasitic diode D1), as illustrated in FIG. 13.

When a large charging current flows through the parasitic diode D1 and the first FET 121 is out of the safe operating area of the I-T characteristic, the first FET 121 may break down due to generation of heat by the parasitic diode D1.

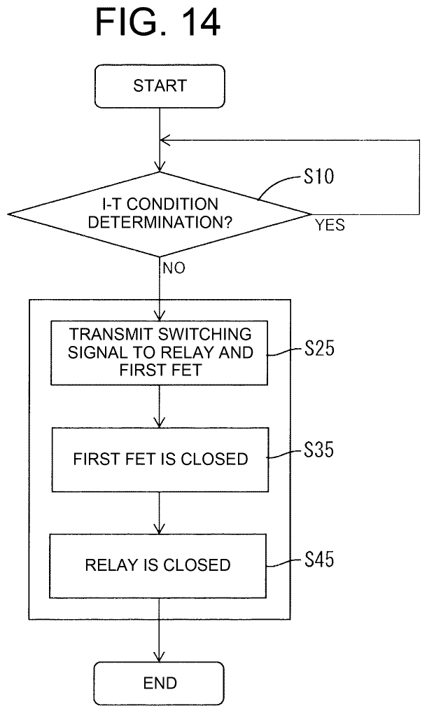

FIG. 14 is a flowchart of FET protection processing. The FET protection processing is executed in a case of, as illustrated in FIG. 13, opening a relay 53, opening a first FET 121, and closing a second FET 123, and permitting only a charge (in which a discharge is restricted) through a path passing through a parasitic diode D1 of the first FET 121, after the relay 53 is shut off in accordance with over-discharge detection.

After opening the relay 53 by detection of an overcharge, a management device 150 determines whether an operating point P of the first FET 121 is on the lower side of the I-T determination line F0 indicated in FIG. 9 (S10).

If the operating point P of the first FET 121 has exceeded the I-T determination line F0, the management device 150 transmits switching signals to the relay 53 and the first FET 121 (S25).

Since an operation time of the FET is shorter than an operation time of the relay 53, the first FET 121 is closed first (S35). An allowable current between the drain and the source of the first FET 121 is greater than an allowable current of the parasitic diode D1. Therefore, after the first FET 121 has been closed, an energizable current of the bypass circuit 120 can be increased. Therefore, it is possible to suppress a breakdown of the first FET 121 due to the heat generation.

After the first FET 121 has been closed, the relay 53 is closed later (S45). When the relay 53 is closed, after the closure, most of the discharge current flows through the relay 53. Thus, the current of the bypass circuit 120 is decreased and heat generation of the first FET 121 is further suppressed.

### Embodiment 4

A management device 150 may detect a breakdown of a relay 53 by using a bypass circuit 120. Breakdown detection may be performed during a period in which a battery 50 is not used such as when a vehicle is parked.

In the following, breakdown detection processing will be described.

After a contact 53A of the relay 53 has been switched from “closed” to “open”, a first FET 121 is closed and a second FET 123 is opened, and a voltage at point B indicated in FIG. 5 is detected by the management device 150.

When the relay 53 is operating normally (i.e., when the contact 53A is open), the voltage at point B is lower than a voltage at the positive pole of an assembled battery 60 (i.e., the voltage at point A) by a voltage drop of a parasitic diode D2.

When an abnormality occurs in the relay 53 (i.e., when the contact 53A is not opened), the voltage at point B is to have the same potential as the voltage at the positive pole of the assembled battery 60 (i.e., the voltage at point A). Therefore, it is possible to detect a closing breakdown of the relay 53 (i.e., a breakdown in which the relay 53 is fixedly closed and does not open) on the basis of the voltage at point B.

When it is confirmed that the relay 53 opens normally, the relay 53 is closed and the voltage at point B is detected by the management device 150.

When the relay 53 is operating normally (i.e., when the contact 53A is closed), the voltage at point B has the same potential as the voltage at the positive pole of the assembled battery 60 (i.e., the voltage at point A).

When an abnormality occurs in the relay 53 (i.e., when the contact 53A is not closed), the voltage at point B is to become lower than the voltage at the positive pole of the assembled battery 60 (i.e., the voltage at point A) by a voltage drop of the parasitic diode D2. Therefore, it is possible to detect an opening breakdown of the relay 53 (i.e., a breakdown in which the relay 53 is fixedly opened and does not close) on the basis of the voltage at point B.

In this way, it is possible to diagnose a breakdown of the relay 53 by using the bypass circuit 120. Since the breakdown diagnosis of the relay 53 is performed by using the bypass circuit 120, the breakdown diagnosis may be avoided when the bypass circuit 120 is broken down or when there is a possibility of a breakdown.

A case where there is a possibility of a breakdown in the bypass circuit 120 is, for example, a case where an FET protection operation is executed in accordance with generation of heat by the parasitic diodes D1 and D2.

### Embodiment 5

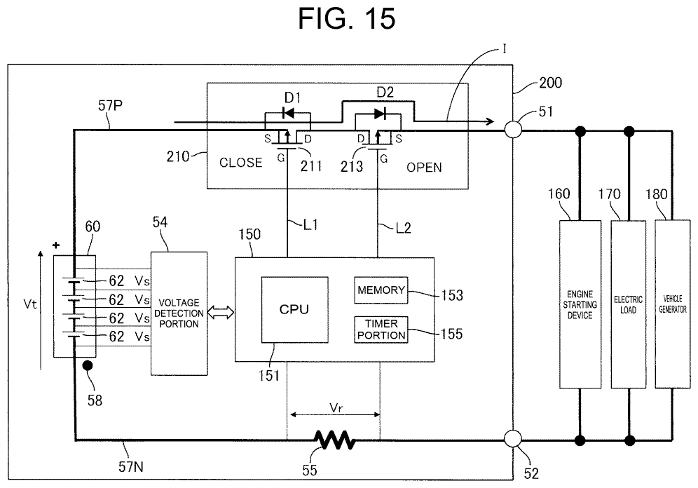

FIG. 15 is a block diagram of a battery 200. The battery 200 is different from the battery 50 of Embodiment 1 in that the relay 53 is replaced with a current cutoff device 210.

The current cutoff device 210 is configured from a first FET 211 and a second FET 213 that are connected back-to-back.

When the battery 200 is overcharged, the first FET 211 is closed and the second FET 213 is opened, whereby a discharge from the battery 200 to an automobile 10 can be performed while restricting a charge by a parasitic diode D2.

If an operating point P of the second FET 213 has exceeded an I-T determination line F0 when a discharge is being performed through a path passing through the parasitic diode D2, a management device 150 closes the second FET 213. By doing so, a breakdown of the second FET 213 due to generation of heat by the parasitic diode D2 can be suppressed.

Further, the first FET 211 may be chosen as the target of protection. That is, when the battery 200 is being charged through a path passing through a parasitic diode D1 by opening the first FET 211 and closing the second FET 213, if an operating point P of the first FET 211 has exceeded the I-T determination line F0, the first FET 211 is closed. By doing so, a breakdown of the first FET 211 due to generation of heat by the parasitic diode D1 can be suppressed.

### OTHER EMBODIMENTS

The present invention is not limited to the embodiments explained referring to the above description and the drawings. The following embodiments, for example, are also included in the technical scope of the present invention.

(1) The cell (repeatedly chargeable and dischargeable energy storage cell) 62 is not limited to a lithium ion secondary battery cell, and may be other non-aqueous electrolyte secondary battery cells. The cells 62 are not necessarily connected in series and parallel. That is, the cells 62 may be connected in series or a single cell may be employed. Instead of the secondary battery cell, a capacitor may be used. The secondary battery cell and the capacitor are examples of the cell.

(2) In the above embodiments, the battery 50 is mounted on the automobile 10. However, the battery 50 may be mounted on a movable body other than a vehicle, such as a ship or an aircraft. Further, the battery 50 may be used for, not limited to the movable body, a stationary application such as an energy storage apparatus for fluctuation absorption in a distributed power generation system, or an uninterruptible power supply (UPS).

(3) In the above embodiments, the relay 53 is disposed on the positive power line 57P, and the current sensor 55 is disposed on the negative power line 57N. Alternatively, the current sensor 55 may be disposed on the positive power line 57P, and the relay 53 may be disposed on the negative power line 57N. Further, in the above-described embodiments, while a P-channel FET is used for the bypass circuit 120, an N-channel FET may be used.

(4) In Embodiment 1 described above, if the operating point P of the second FET 123 exceeds the I-T determination line F0, the processing proceeds to S20, and the management device 150 simultaneously transmits switching signals for making a switch from “open” to “closed” to the relay 53 and the second FET 123. As long as the second FET 123 can be closed before the closure of the contact 53A of the relay 53, the switching signals need not necessarily be transmitted simultaneously. The switching signal may be transmitted to the relay 53 first, and then the switching signal may be transmitted to the second FET 123.

(5) In Embodiment 1 described above, the I-T condition of the second FET 123 is judged (S10), and the FET protection processing (S20 to S40) is executed. The execution of the FET protection processing (S20 to S40) may be judged by another condition as long as the condition is based on the current I and the energization time T of the second FET 123.

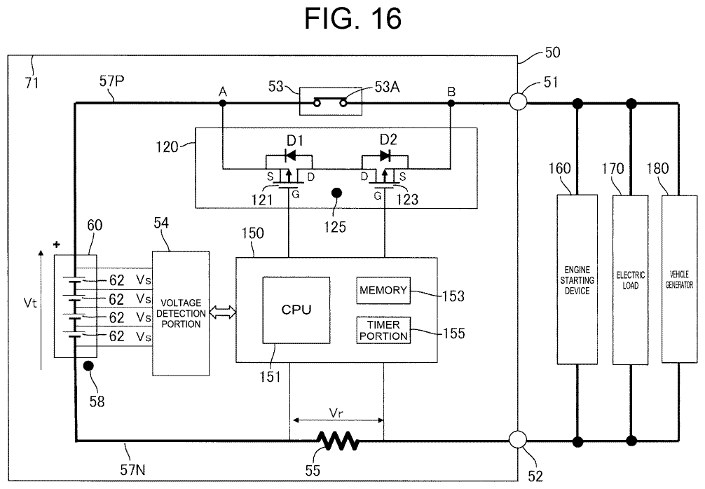

(6) In Embodiment 1 described above, the I-T condition of the second FET 123 is judged (S10), and the FET protection processing (S20 to S40) is executed. Alternatively, a temperature condition of the second FET 123 may be judged (S10) to execute the FET protection processing (S20 to S40). That is, the FET protection processing (S20 to S40) may be executed if the temperature of the second FET 123 exceeds a threshold. In this case, a temperature sensor 125 may be added to the bypass circuit 120 to measure the temperatures of the first FET 121 and the second FET 123 (FIG. 16).

1. An energy storage apparatus comprising:
a cell;
a relay which cuts off a current of the cell;
a bypass circuit connected in parallel with the relay; and
a management device,
wherein the bypass circuit includes two FETs that are connected back-to-back,
when an abnormality of the cell is detected by the management device,
the management device opens the relay, closes one FET of the two FETs, and opens the other FET, and permits a discharge or a charge of the cell through a path passing through a parasitic diode of the FET, and
when the discharge or the charge is being performed through the path passing through the parasitic diode, if a current I and an energization time T of the FET reach a predetermined condition or a temperature of the FET reaches a predetermined condition, the management device closes the relay and the other FET that is open.

2. An energy storage apparatus comprising:
a cell;
a relay which cuts off a current of the cell;
a bypass circuit connected in parallel with the relay; and
a management device,
wherein the bypass circuit includes two FETs that are connected back-to-back,
when an abnormality of the cell is detected by the management device,
the management device opens the relay, closes one FET of the two FETs, and opens the other FET, and permits a discharge or a charge of the cell through a path passing through a parasitic diode of the FET, and
when the discharge or the charge is being performed through the path passing through the parasitic diode, if a current I and an energization time T of the FET reach a predetermined condition or a temperature of the FET reaches a predetermined condition, the management device maintains the relay to be open and closes the other FET that is open.

3. The energy storage apparatus according to claim 1, wherein the abnormality of the cell is an overcharge or an over-discharge.

4. An energy storage apparatus for starting an engine according to claim 1.

5. An energy storage apparatus comprising:
a cell;
a current cutoff device which cuts off a current of the cell; and
a management device,
wherein the current cutoff device includes two FETs that are connected back-to-back,
when an abnormality of the cell is detected by the management device,
the management device closes one FET of the two FETs and opens the other FET, and permits a discharge or a charge of the cell through a path passing through a parasitic diode of the FET, and
when the discharge or the charge is being performed through the path passing through the parasitic diode, if a current I and an energization time T of the FET reach a predetermined condition or a temperature of the FET reaches a predetermined condition, the management device closes the other FET that is open.

6. The energy storage apparatus according to claim 2, wherein the abnormality of the cell is an overcharge or an over-discharge.

7. An energy storage apparatus for starting an engine according to claim 2.

8. The energy storage apparatus according to claim 5, wherein the management device closes the other FET that is open if the current I and the energization time T of the FET is out of a safe operating area in an I-T characteristic of the FET.

9. The energy storage apparatus according to claim 8, wherein different currents are associated with different times in the I-T characteristic of the FET.

10. The energy storage apparatus according to claim 9, wherein a grater time is associated with a smaller current in the I-T characteristic of the FET.
